(19) United States
(12) Patent Application Publication
(10) Pub. No.: US 2012/0044138 A1
(43) Pub. Date: Feb. 23, 2012

(54) METHOD AND APPARATUS FOR PROVIDING USER INTERACTION IN LASeR

(75) Inventors: Injae Lee, Daejon (KR); Jihun Cha, Daejon (KR); Han-Kyu Lee, Daejon (KR); Jin-Woo Hong, Daejon (KR); Young-Kwon Lim, Kyunggi-do (KR)

(73) Assignees: NET&TV INC., Seoul (KR); Electronics and Telecommunications Research Institute, Daejon (KR)

(21) Appl. No.: 13/264,716

(22) PCT Filed: Apr. 14, 2010
(86) PCT No.: PCT/KR2010/002317

§ 371 Date: Oct. 14, 2011

Related U.S. Application Data
(60) Provisional application No. 61/168,966, filed on Apr. 14, 2009.
(60) Provisional application No. 61/171,136, filed on Apr. 21, 2009.
(60) Provisional application No. 61/295,283, filed on Jan. 15, 2010.

(51) Int. Cl. G06F 3/01; G06F 3/048

(52) U.S. Cl. 345/156; 715/769

(57) ABSTRACT

A method and an apparatus for providing user interaction are provided. The apparatus for providing user interaction includes an input unit configured to receive control by a user; a control processing unit configured to analyze the control and generate drag event information including event type information indicating a type of the control and event attribute information; and an action processing unit configured to generate drag element information for showing an action corresponding to the control on a display. The drag element information includes action mode information indicating a mode of the action and action attribute information. The proposed method and apparatus make it possible to apply various data formats defined by existing standard specifications to other standard specifications and interaction devices.

### TECHNICAL FIELD

Exemplary embodiments of the present invention relate to a method and an apparatus for providing user interaction; and, more particularly, to a method and an apparatus for providing user interaction in LASeR.

### BACKGROUND ART

A number of approaches for solving problems concerning presentation of structured information have been proposed. The first one is a program-oriented approach employing a script, and the second one is a declarative approach which defines additional information within presentation.

The program-oriented approach using a script can provide a substantially unlimited method for accessing structured information, and thus can be a very useful tool. However, this approach requires that the contents author must be able to use a specific script language and have a predetermined level of scripting knowledge, making it difficult to author LASeR contents used for presentation of structured information. Furthermore, the program-oriented approach can hardly take full advantage of LASeR, which is a declarative language.

As used herein, Light Application Scene Representation (LASeR) refers to multimedia contents specification suitable for low-spec devices, such as mobile phones, and can provide LASeR contents or a combination of wireless portals, mobile TV, music, personal services, and the like through a LASeR-based system, and can implement vivid dynamic effect, interactive interface, etc.

Therefore, it is more efficient to adopt a declarative approach, which can retain the advantage of LASeR, for the purpose of presentation of structured information.

### DETAILED DESCRIPTION OF THE INVENTION

### Technical Problem

An embodiment of the present invention is directed to a method and an apparatus for providing user interaction, which can recognize control inputted by a user and efficiently show it on a display.

Another embodiment of the present invention is directed to a method and an apparatus for providing user interaction, which can provide the user with useful information by visualizing sensory effect based on sensed information on a display.

Another embodiment of the present invention is directed to a method and an apparatus for providing user interaction, which make it possible to apply various data formats defined by existing standard specifications to other standard specifications and interaction devices.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### Technical Solution

In accordance with an embodiment of the present invention, an apparatus for providing user interaction includes: an input unit configured to receive control by a user; a control processing unit configured to analyze the control and generate drag event information including event type information indicating a type of the control and event attribute information; and an action processing unit configured to generate drag element information for showing an action corresponding to the control on a display with reference to the drag event information, wherein the drag element information includes action mode information indicating a mode of the action and action attribute information.

In accordance with another embodiment of the present invention, a method for providing user interaction includes: receiving control by a user; analyzing the control and generating drag event information including event type information indicating a type of the control and event attribute information; and generating drag element information for showing an action corresponding to the control on a display with reference to the drag event information, wherein the drag element information includes action mode information indicating a mode of the action and action attribute information.

In accordance with another embodiment of the present invention, an apparatus for providing user interaction includes: an input unit configured to receive sensed information acquired by a sensor; and a control unit configured to generate external sensor event information for visualizing the sensed information on a display.

In accordance with another embodiment of the present invention, a method for providing user interaction includes: receiving sensed information acquired by a sensor; and generating external sensor event information for visualizing the sensed information on a display.

### ADVANTAGEOUS EFFECTS

In accordance with the exemplary embodiments of the present invention, the method and apparatus for providing user interaction can recognize control inputted by a user and efficiently show it on a display.

In addition, the method and apparatus for providing user interaction can provide the user with useful information by visualizing sensory effect based on sensed information on a display.

Furthermore, the method and apparatus for providing user interaction make it possible to apply various data formats defined by existing standard specifications to other standard specifications and interaction devices.

### BRIEF DESCRIPTION OF THE DRAWINGS

FIG. 1 illustrates relationship between scene presentation (e.g. LASeR) and sensed information using data formats of MPEG-V Part 5 for interaction devices.

FIG. 2 illustrates construction of an apparatus for providing user interaction in accordance with an embodiment of the present invention.

FIG. 3 illustrates a multimedia terminal to which a method for providing user interaction in accordance with an embodiment of the present invention can be applied.

FIG. 4 is a flowchart of a method for providing user interaction in accordance with an embodiment of the present invention.

FIG. 5 illustrates construction of an apparatus for providing user interaction in accordance with an embodiment of the present invention.

FIG. 6 illustrates a scene visualizing sensed information (temperature) in accordance with an embodiment of the present invention.

FIG. 7 illustrates a scene visualizing sensed information (humidity) in accordance with an embodiment of the present invention.

FIG. 8 is a flowchart of a method for providing user interaction in accordance with an embodiment of the present invention.

### BEST MODES

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

A device for playing multimedia contents may use a continuous controller, such as a slider or a knob. In order to track control of the user by the continuous controller, a program-oriented approach using a script may be adopted. However, the program-oriented approach may force use of a specific script language, which has been avoided in the process of development of LASeR standards as the most serious restriction. The present invention is directed to a method and an apparatus for providing user interaction based on a declarative approach in order to process control by a continuous controller.

Furthermore, MPEG-V, standardization of which is recently in progress, define use of various sensory effects and sensory devices. The present invention is directed to a method and an apparatus for providing user interaction, which can provide the user with useful information regarding various sensory effects more efficiently using the MPEG-V data formats and LASeR standard specifications.

1. Introduction

Disclosure of the present invention includes a mechanism for using data formats (MEPG-V Part 5 Sensed Information) for interaction devices. The present invention also provides technologies related to advanced user interaction available in LASeR. For each technology, syntax, semantics, and examples are provided.

Recently, in MPEG, standard specifications are being established to support various aspects of media context and control (MPEG-V). Specifically, Part 5 of MPEG-V defines data formats for various advanced interaction devices (actuators and sensors). Therefore, it is reasonable to use existing data formats so that they are applicable to other various standard specifications. The present invention includes technical elements for accommodating such data formats in LASeR.

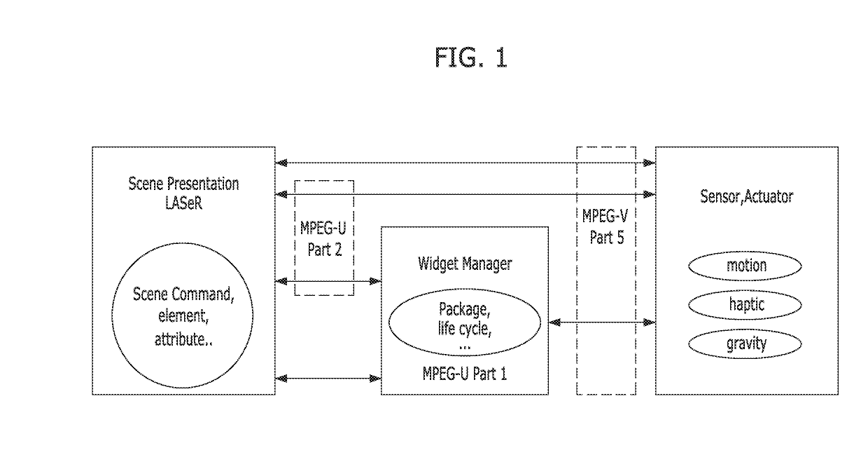

As used herein, “advanced” user interaction refers to interaction using sensory devices, such as a light sensor, a motion sensor, and the like, which have recently been used. FIG. 1 illustrates relationship between scene presentation (e.g. LASeR) and sensed information using data formats of MPEG-V Part 5 for interaction devices. In FIG. 1, MPEG-U refers to standard specifications regarding communication between widgets, communication between a widget and an external terminal, etc.

2. Drag Event Information and Drag Element Information

Drag event information and drag element information in accordance with the present invention will now be described. It is to be noted that, although the present invention will be described with reference to drag event information and drag element information applicable to LASeR standards, the scope of the present invention is not limited thereto.

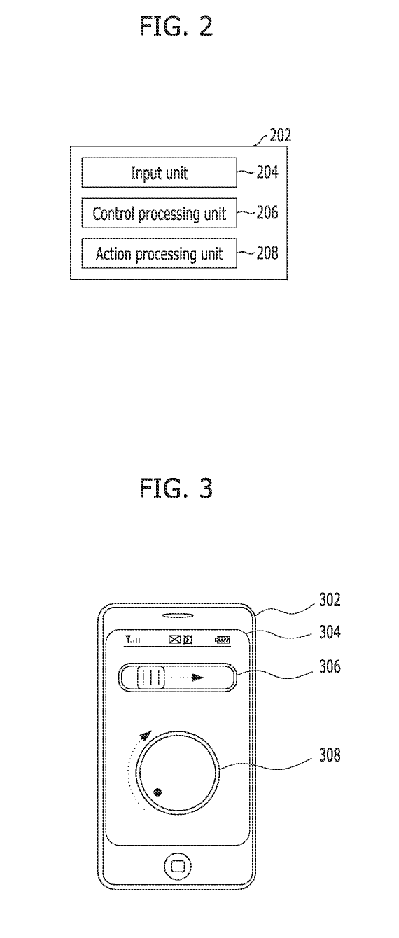

FIG. 2 illustrates construction of an apparatus for providing user interaction in accordance with an embodiment of the present invention.

The apparatus 202 for providing user interaction includes an input unit 204, a control processing unit 206, and an action processing unit 208. The input unit 204 is configured to receive control inputted by the user, specifically, receive control (e.g. click, drag, drop) using an input device (e.g. mouse, touchpad).

The control processing unit 206 is configured to analyze the user's control inputted through the input unit 204 and generate drag event information. The drag event information may include event type information, which indicates the type of inputted control, and event attribute information, which corresponds to a value generated based on the inputted control.

The action processing unit 208 is configured to generate drag element information with reference to the drag event information generated by the control processing unit 206. The drag element information is used to show an action, which corresponds to the user's control inputted through the input unit 204, on a display. The drag element information may include action mode information, which indicates the mode of an action to be shown on the display, and action attribute information, which indicates the attribute of the corresponding action.

Next, drag event information and drag element information generated in accordance with an embodiment of the present invention will be described in detail.

The drag event information refers to information regarding drag and drop actions by the user. The drag event information includes event type information and event attribute information.

More specifically, the event type information includes one of drag type information and drop type information. The drag event information includes event attribute information based on drag type information or drop type information.

The drag type indicates a dragging motion analyzed two-dimensionally on x-y plane of local space. The drag type may be a mouse down event action followed by a continuous mousemove event. Bubbling of the drag type is impossible, and is not cancelable. When event type information includes drag type information, event attribute information included in the event type information may include maximum angle information (maxAngle), minimum angle information (minAngle), current angle information (currentAngle), maximum position information (maxPosition), minimum position information (minPosition), and current position information (currentPosition).

The drop type indicates a triggering action, i.e. release of an object into two-dimensional space by the mouse on x-y plane of local space. Bubbling of the drag type is impossible, and is not cancelable. When event type information includes drop type information, event attribute information included in the event type information may include maximum angle information (maxAngle), minimum angle information (minAngle), current angle information (currentAngle), maximum position information (maxPosition), minimum position information (minPosition), and current position information (currentPosition).

For reference, the proceeding of an event may be divided into a capture phase and a bubble phase. In the capture phase, based on DOM tree, an event starts at the highest document and proceeds to the target object, and in the bubble phase, on the contrary, an event proceeds from the target object to the highest document.

An example of drag event information in LASeR is as follows:

```
<?xml version=″1.0″ encoding=″ISO-8859-1″ ?>
  <saf:SAFSession xmlns:saf=″urn:mpeg:mpeg4:SAF:2005″
  xmlns:xlink=″http://www.w3.org/1999/xlink″
  xmlns:ev=http://www.w3.org/2001/xml-events
xmlns:lsr=″urn:mpeg:mpeg4:LASeR:
  2005″ xmlns=″http://www.w3.org/2000/svg″>
  <saf:sceneHeader>
    <lsr:LASeRHeader />
  </saf:sceneHeader>
  <saf:sceneUnit>
    <lsr:NewScene>
    <svg width=″176″ height=″144″>
      <g>
      <rect x=″1″ y=″1″ width=″598″ height=″498″ fill=″none″
stroke=″blue”>
        <handler type=″application/ecmascript″ ev:event=″drag″>
        Slide_image(evt);
        </handler>
      </rect>
      <lsr:selector translation=″20 20″ choice=″1″>
        <image x=″25″ y=″315″ width=″360″ height=″240″
xlink:href=″IMG_1.jpg″/>
        <image x=″25″ y=″315″ width=″360″ height=″240″
xlink:href=″IMG_2.jpg″/>
        <image x=″25″ y=″315″ width=″360″ height=″240″
xlink:href=″IMG_3.jpg″/>
        <image x=″25″ y=″315″ width=″360″ height=″240″
xlink:href=″IMG_4.jpg″/>
        <image x=″25″ y=″315″ width=″360″ height=″240″
xlink:href=″IMG_5.jpg″/>
      </lsr:selector>
?
      <script type=″application/ecmascript″> <![CDATA[
        function silde_image(evt) {
        ...
      }
      ]]> </script>
      </g>
    </svg>
    </lsr:NewScene>
  </saf:sceneUnit>
  <saf:endOfSAFSession />
</saf:SAFSession>
```

The drag element information is used, when continuous control occurs (e.g. when the slide bar is slid or the knob is rotated), to show a corresponding action on the display. A drag element may be a child of video, image, or graphical elements. Elements that can be a parent of a drag element include circle, ellipse, g, image, line, polygon, polyline, path, rect, svg, tect, textArea, video, etc. The drag element information includes action mode information and action attribute information.

The action mode information includes one of drag plane mode information and drag rotation mode information. The drag element information includes action attribute information based on the action mode information.

The drag plane mode indicates a dragging motion analyzed two-dimensionally on x-y plane of local space. For example, when the user moves the slide bar from left to right on the display with the mouse, animation of the slide bar moving linearly appears on the display. This is a drag plane mode.

When the drag element information includes a drag plane mode, action attribute information included in the drag element may include maximum position information (maxPosition), minimum position information (minPosition), offset information (offsetT), and target element information (xlink:href).

The maximum position information indicates the maximum X and Y positions of the corresponding scene, and the default value is 0, 0. The minimum position information indicates the minimum X and Y positions of the corresponding scene, and the default value is −1, −1. The offset information indicates the tick of dragging distance analyzed along x and/or y axis between pixels, and the default value is 0, 0. The target element information indicates elements that are targets of dragging actions.

When the drag element information includes a drag rotation mode, action attribute information included in the drag element may include maximum angle information (maxAngle), minimum angle information (minAngle), offset information (offsetA), and target element information (xlink:href).

The maximum angle information indicates the maximum allowable rotation range in radian, and the default value is 0. The minimum angle information indicates the minimum allowable rotation range in radian, and the default value is −1. The offset information indicates the tick of rotation angle, and the default value is 0. The target element information indicates elements that are targets of dragging actions.

An example of drag element information in LASeR is as follows:

```
<?xml version=″1.0″ encoding=″ISO-8859-1″ ?>
  <saf:SAFSession xmlns:saf=″urn:mpeg:mpeg4:SAF:2005″
  xmlns:xlink=″http://www.w3.org/1999/xlink″
  xmlns:ev=http://www.w3.org/2001/xml-events xmlns:lsr=″urn:mpeg:
  mpeg4:LASeR:2005″ xmlns=″http://www.w3.org/2000/svg″>
  <saf:sceneHeader>
    <lsr:LASeRHeader />
  </saf:sceneHeader>
  <saf:sceneUnit>
    <lsr:NewScene>
    <svg width=″176″ height=″144″>
      <g>
? <image id=”img1” x=″0″ y=″30″ width=″30″ height=″40″
        xlink:href=″IMG_1.jpg″/>
      <image id=”img2” x=″50″ y=″60″ width=″30″ height=″40″
        xlink:href=″IMG_2.jpg″/>
      <Drag begin=”img1.drag” xlik:href=”#img1”
        mode=”dragRotation” offsetA=”0.3”/>
      <Drag begin=”img2.drag” xlik:href=”#img2”
        mode=”dragPlane” minPosition=”0 0” maxPosition=”100 0”>
? </g>
    </svg>
    </lsr:NewScene>
  </saf:sceneUnit>
  <saf:endOfSAFSession />
</saf:SAFSession>
```

FIG. 3 illustrates a multimedia terminal to which a method for providing user interaction in accordance with an embodiment of the present invention can be applied.

The multimedia terminal 302 includes a display 304. The display 304 may be a conventional display (e.g. LCD) so that the user can input control through an input device (e.g. mouse), or a touch screen which enables control by touch.

The display 304 of the multimedia terminal 302 can display a slide bar object 306 or a knob object 308 as illustrated in FIG. 3. When the user clicks the slide bar object 306 or the knob object 308 with the mouse or finger, drags it, and drops it, this series of control is inputted through the input unit 204 of the apparatus 202 for providing user interaction illustrated in FIG. 2.

The control processing unit 206 then analyzes the control inputted through the input unit 204 and determines whether the control is a drag type or a drop type. The control processing unit 206 also grasps attribute values resulting from the drag or drop action by the user, specifically, maximum angle, minimum angle, current angle, maximum position, minimum position, current position, etc. Using these pieces of information, the control processing unit 206 generates drag event information including event type information and event attribute information, and transfers the generated drag event information to the action processing unit 208.

The action processing unit 208 recognizes the user's control with reference to the drag event information generated by the control processing unit 206, and generates drag element information for showing an action, which corresponds to the control, on the display 304.

If the user has moved the slide bar 306 along the arrow, the action processing unit 208 generates drag element information for processing animation of moving the slide bar 306 object on the display 304 along the arrow. The drag element information is supposed to include action mode information including drag plane information and related action attribute information.

If the user has rotated the knob 308 along the arrow, the action processing unit 208 generates drag element information for processing animation of moving the knob 306 object on the display 304 along the arrow. The drag element information is supposed to include action mode information including drag rotation information and related action attribute information.

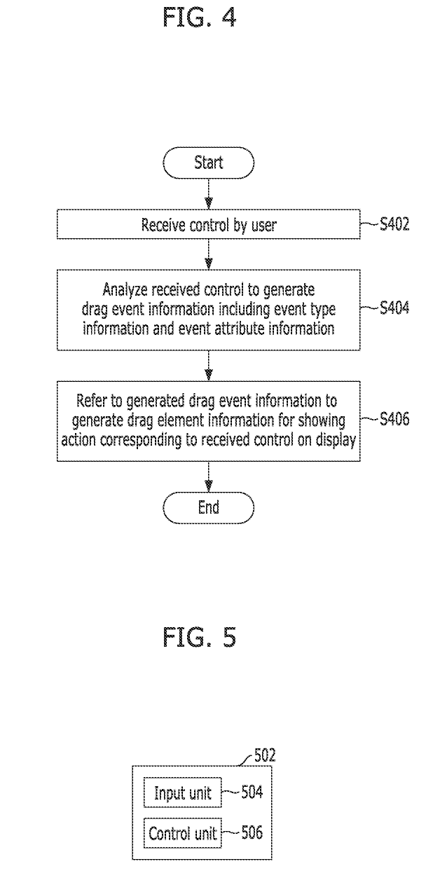

FIG. 4 is a flowchart of a method for providing user interaction in accordance with an embodiment of the present invention.

Firstly, control by the user is received at step S402. The received control is analyzed to generate drag event information including event type information and event attribute information at step S404.

Reference is made to the generated drag event information to generate drag element information for showing an action corresponding to the received control on the display at step S406. The drag element information includes action mode information and action attribute information.

3. External Sensor Event Information

External sensor event information in accordance with the present invention will now be described. It is to be noted that, although the present invention will be described with reference to an example of external sensor event information applicable to LASeR standards, the scope of the present invention is not limited thereto.

An external event of LASeR for data formats of MPEG-V Part 5 sensed information is requested. There are a number of methods for using sensed information in LASeR. One method is to find a new external event for LASeR. The present invention provides a new event and related IDL definition. Together with such an event, LASeR can use various types of input information from various industry-supported sensors.

As used herein, sensors or actuators refer to devices capable of showing various sensory effects, and information collected by such sensors is referred to as sensed information. In accordance with an embodiment of the present invention, 17 different sensors and attribute values for respective sensors are used as defined in Table 1 below.

TABLE 1

| | Sensor type | Attributes |
|---|---|---|
| Sensed | Light sensor | f.timestamp, s.unit, f.value, s.color |
| Infor- | Ambient noise | f.timestamp, s.unit, f.value |
| mation | sensor | |
| | Temperature sensor | f.timestamp, s.unit, f.value |
| | Humidity sensor | f.timestamp, s.unit, f.value |
| | Length sensor | f.timestamp, s.unit, f.value |
| | Atmospheric | f.timestamp, s.unit, f.value |
| | pressure sensor | |
| | Position sensor | f.timestamp, s.unit, f.Px, f.Py, f.Pz |
| | Velocity sensor | f.timestamp, s.unit, f.Vx, f.Vy, f.Vz |
| | Acceleration sensor | f.timestamp, s.unit, f.Ax, f.Ay, f.Az |
| | Orientation sensor | f.timestamp, s.unit, f.Ox, f.Oy, f.Oz |
| | Angular velocity | f.timestamp, s.unit, f.AVx, f.AVy, f.AVz |
| | sensor | |
| | Angular acceleration | f.timestamp, s.unit, f.AAx, f.AAy, f.AAz |
| | sensor | |
| | Force sensor | f.timestamp, s.unit, f.FSx, f.FSy, f.FSz |
| | Torque sensor | f.timestamp, s.unit, f.TSx f.TSy f.TSz |
| | Pressure sensor | f.timestamp, s.unit, f.value |
| | Motion sensor | f.timestamp, f.Px, f.Py, f.Pz, f.Vx, f.Vy, |
| | | f.Vz, f.Ox, f.Oy, f.Oz, f.AVx, f.AVy, |
| | | f.Avz, f.Ax, f.Ay, f.Az, f.AAx, f.AAy, |
| | | f.AAz |
| | Intelligent Camera | f.timestamp, FacialAnimationID, |
| | | BodyAnimationID, FaceFeatures(f.Px f.Py |
| | | f.Pz), BodyFeatures(f.Px f.Py f.Pz) |

In accordance with an embodiment of the present invention, for the purpose of generic use of different attribute values given in Table 1, attributes for external sensor event information are defined as below (IDL definition).

```
interface externalSensorEvent : LASeREvent {
typedef float fVectorType[3];
typedef sequence<fVectorType> fVectorListType;
        readonly attribute string unitType;
        readonly attribute float time;
        readonly attribute float fValue;
        readonly attribute string sValue;
        readonly attribute fVectorType fVectorValue;
        readonly attribute fVectorListType fVectorList1;
        readonly attribute fVectorListType fVectorList2;
};
```

The meaning of attributes defined in above IDL definition is as follows:
fVectorType: indicates a 3D vector type consisting of three floating point numbers.
fVectorListType: indicates a list type of at least one 3D float vector.
unitType: indicates a unit in string type (e.g. Lux, Celsius, Fahrenheit, mps, mlph).
time: indicates sensed time as a float value.
fValue: indicates a float value.
sValue: indicates a string value.
fVectorValue: indicates a float vector.
fVectorList1, fVectorList2: indicates a float vector list having unlimited vectors.

The above IDL definition is for the purpose of classifying the attributes given in Table 1 according to a predetermined criterion so that, when user interaction in accordance with the present invention is provided, corresponding attributes can be used more conveniently.

Table 2 below enumerates event type information and event attribute value information, which are included in external sensor event information in accordance with an embodiment of the present invention, as well as the attribute of each event attribute value information.

TABLE 2

| | Context Info | | | Can- |
|---|---|---|---|---|
| Event Type | Syntax | Semantics | Bubbles | celable |
| Light | fValue | Describes the value of the light | No | No |
| | | sensor with respect to Lux. | | |
| | sValue | Describes the color which the lighting | | |
| | | device can provide as a reference to | | |
| | | a classification scheme term or as | | |
| | | RGB value. | | |
| AmbientNoise | fValue | Describes the value of the ambient | No | No |
| | | noise sensor with respect to decibel | | |
| | | (dB) | | |
| Temperature | fValue | Describes the value of the | No | No |
| | | temperature sensor with respect to | | |
| | | the celsius scale. | | |
| Humidity | fValue | Describes the value of the humidity | No | No |
| | | sensor with respect to percent (%). | | |
| Length | fValue | Describes the value of the length | No | No |
| | | sensor with respect to meter (m). | | |
| Atmospheric | fValue | Describes the value of the | No | No |
| pressure | | atmospheric pressure sensor with | | |
| | | respect to hectopascal (hPa). | | |
| Position | fVectorValue | Describes the 3D value of the | No | No |
| | | position sensor with respect to meter | | |
| | | (m). | | |
| Velocity | fVectorValue | Describes the 3D vector value of the | No | No |
| | | velocity sensor with respect to meter | | |
| | | (m/s). | | |
| Acceleration | fVectorValue | Describes the 3D vector value of the | No | No |
| | | acceleration sensor with respect to | | |
| | | m/s². | | |
| Orientation | fVectorValue | Describes the 3D value of the | No | No |
| | | orientation sensor with respect to | | |
| | | meter (radian). | | |
| AngularVelocity | fVectorValue | Describes the 3D vector value of the | No | No |
| | | AngularVelocity sensor with respect | | |
| | | to meter (radian/s). | | |
| AngularAcceleration | fVectorValue | Describes the 3D vector value of the | No | No |
| | | AngularAcceleration sensor with | | |
| | | respect to meter (radian/s²). | | |
| Force | fVectorValue | Describes the 3D value of the force | No | No |
| | | sensor with respect to N(Newton). | | |
| Torque | fVectorValue | Describes the 3D value of the torque | No | No |
| | | sensor with respect to N-mm (Newton | | |
| | | millimeter). | | |
| Pressure | fValue | Describes the value of the pressure | No | No |
| | | with respect to N/mm² | | |
| | | (Newton/millimeter square). | | |
| Motion | fVectorList1 | Describes the 6 vector values: | No | No |
| | | position, velocity, acceleration, | | |
| | | orientation, AngularVelocity, | | |
| | | AngularAcceleration. | | |
| Intelligent | fVectorList1 | Describes the 3D position of each of | No | No |
| Camera | | the face feature points detected by | | |
| | | the camera. | | |
| | fVectorList2 | Describes the 3D position of each of | | |
| | | the body feature points detected by | | |
| | | the camera. | | |

Each event type has an event attribute value, and each event attribute value has an attribute of one of unitType, time, fValue, sValue, fVectorValue, and fVectorList, which are defined by IDL definition, specifically, unitType type, time type, float Value type, string Value type, float Vector Value type, and float Vector List type. For example, the light type has attribute values of ‘luminance’ (lux unit) and ‘color’, which have attributes of fValue and sValue, respectively.

FIG. 5 illustrates construction of an apparatus for providing user interaction in accordance with an embodiment of the present invention.

The apparatus 502 for providing user interaction includes an input unit 504 and a control unit 506. The input unit 504 is configured to receive sensed information acquired by a sensor (e.g. light sensor, temperature sensor). For example, based on sensory effect information included in contents, the light sensor provides light suitable for corresponding contents when the contents are played. At the same time, the light sensor may recognize the light condition of the current contents playback environment and again provide the playback system with it. In this connection, information indicating the condition of the playback environment sensed by the sensor is referred to as sensed information. The contents playback system can play contents better suited to the current playback environment based on the sensed information.

The control unit 506 is configured to generate external sensor event information for visualizing sensed information on the display. The external sensor event information may include event type information and event attribute value information. The event type information may include one of light type information, ambient noise type information, temperature type information, humidity type information, length type information, atmospheric pressure type information, position type information, velocity type information, acceleration type information, orientation type information, angular velocity type information, angular acceleration type information, force type information, torque type information, pressure type information, motion type information, and intelligent camera type information. The event attribute value information may indicate an attribute of one of uniType type, time type, float Value type, string Value type, float Vector Value type, and float Vector List type. The controller 506 can visualize sensed information on the display using the generated external sensor event information. For example, an event type, an event attribute value, and a visualization object can appear on the display, and the visualization object can vary as the event attribute value changes.

An example of visualization of sensed information by the apparatus 502 for providing user interaction will now be described.

Assuming that the input unit 504 has received sensed information acquired by the temperature sensor, the control unit 506 can visualize the sensed information on the display so that the user can check the current temperature of his/her environment in real time. An example of external sensor event information is given below:

```
<?xml version=″1.0″ encoding=″ISO-8859-1″ ?>
<saf:SAFSession xmlns:saf=″urn:mpeg:mpeg4:SAF:2005″
xmlns:xlink=″http://www.w3.org/1999/xlink″
xmlns:ev=http://www.w3.org/2001/xml-events
xmlns:lsr=″urn:mpeg:mpeg4:LASeR:2005″
xmlns=″http://www.w3.org/2000/svg″>
<saf:sceneHeader>
<lsr:LASeRHeader />
</saf:sceneHeader>
<saf:sceneUnit>
<lsr:NewScene>
<svg xmlns=http://www.w3.org/2000/svg >
  <g onTemperature=“Temperature_change(evt)” >
    <text id=“temp_text” x=10” y=“50”> </text>
<rect id=″temp_rect″ x=″50″ y=″50″ width=″50″ height=″50″
fill=″green″/>
    </g>
    <script id=“temp” type=″text/ecmascript″>
        <![CDATA[
            function Temperature_change(evt) {
                var evtText, evtRect, text;
                evtText = document.getElementById(“temp_text”);
evtRect = document.getElementById(“temp_rect”);
                text = evt.fValue;
*212 evtText.firstChild.nodeValue = text;
if(evt.fValue > 30)
evtRect.setAttributeNS(null,”fill”,”red”);
else if(evt.fValue < 10)
evtRect.setAttributeNS(null,”fill”,”blue”);
                  else
evtRect.setAttributeNS(null,”fill”,”green”);
            }
        ]]>
    </script>
</svg>
</lsr:NewScene>
</saf:sceneUnit>
<saf:endOfSAFSession />
</saf:SAFSession>
```

The above external sensor event information includes event type information (<g on Temperature=“Temperature_change(evt)”>) and event attribute value information (text=evt.fValue;). The event attribute value information has an attribute of float Value type (text=evt.fValue;).

The above external sensor event information also defines a rectangular object for visualizing a temperature value, and the default value of the object is green (<rect id=“temp_rect” x=“50” y=“50” width=“50” height=“50” fill=“green”/>).

Codes staring from “if(evt.fValue>30)” define that the rectangular object is filled with red color when the temperature is above 30°, blue color when the temperature is below 10°, and green color in remaining cases.

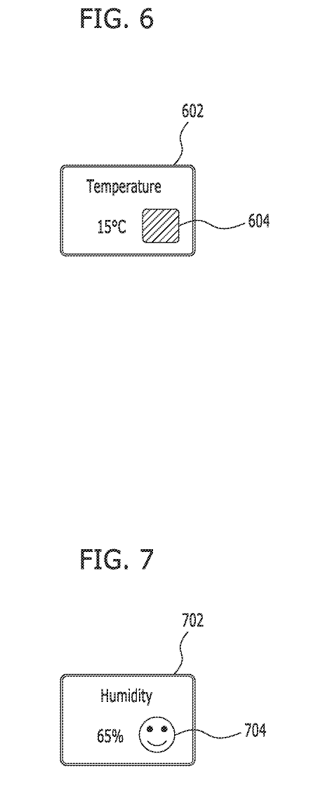

Based on such external sensor event information, visualization information as illustrated in FIG. 6 can be shown on the display. The visualization information box 602 shows the current temperature (Celsius) under the title “Temperature”, and includes a rectangular object 604 visualizing the current temperature.

Assuming that the input unit 504 has received sensed information acquired by the humidity sensor, an example of external sensor event information is given below:

```
<?xml version=″1.0″ encoding=″ISO-8859-1″ ?>
<saf:SAFSession xmlns:saf=″urn:mpeg:mpeg4:SAF:2005″
xmlns:xlink=″http://www.w3.org/1999/xlink″
xmlns:ev=http://www.w3.org/2001/xml-events
xmlns:lsr=″urn:mpeg:mpeg4:LASeR:2005″
xmlns=″http://www.w3.org/2000/svg″>
<saf:sceneHeader>
<lsr:LASeRHeader />
</saf:sceneHeader>
<saf:imageHeader streamID=″S1″ streamType=″4″
objectTypeIndication=″109″ source=″face_smile.png″/>
<saf:imageHeader streamID=″S2″ streamType=″4″
objectTypeIndication=″109″ source=″face_frown.png″/>
<saf:imageHeader streamID=″S3″ streamType=″4″
objectTypeIndication=″109″ source=″face_tears.png″/>
<saf:sceneUnit>
<lsr:NewScene>
<svg xmlns=http://www.w3.org/2000/svg >
  <g onHumidity=“Humidity_change(evt)” >
<text x=”50” y=“20”>Humidity</text>
    <text id=“humidity_text” x=”10” y=“50”> </text>
<text x=”20” y=“50”>%</text>
<image id=″s1″ x=″80″ y=″50″ width=″50″ height=″50″
type=″image/png″ xlink:href=″#S1″ fill=″#000000″
visibility =”hidden”/>
<image id=″s2″ x=″80″ y=″50″ width=″50″ height=″50″
type=″image/png″ xlink:href=″#S2″ fill=″#000000″
visibility =”hidden”/>
<image id=″s3″ x=″40″ y=″50″ width=″60″ height=″60″
type=″image/png″ xlink:href=″#S3″ fill=″#000000″
visibility =”hidden”/>
</g>
    <script id=“humidity” type=″text/ecmascript″>
        <![CDATA[
            function Humidity_change(evt) {
                var evtText, textContent, evtImage1,
evtImage2, evtImage3;
                evtText =
                document.getElementById(“humidity _text”);
evtImage1 = document.getElementById(“s1”);
evtImage2 = document.getElementById(“s2”);
evtImage3 = document.getElementById(“s3”);
                textContent = evt.fValue;
                evtText.firstChild.nodeValue = textContent;
if(evt.fValue > 80) {
evtImage1.setAttributeNS(null,”visibility”,”hidden”);
evtImage2.setAttributeNS(null,”visibility”,”hidden”);
evtImage3.setAttributeNS(null,”visibility”,”visible”);
                    }
else if(evt.fValue < 30) {
evtImage1.setAttributeNS(null,”visibility”,”hidden”);
evtImage2.setAttributeNS(null,”visibility”,”visible”);
evtImage3.setAttributeNS(null,”visibility”,”hidden”);
                    }
                    else {
evtImage1.setAttributeNS(null,”visibility”,”visible”);
evtImage2.setAttributeNS(null,”visibility”,”hidden”);
evtImage3.setAttributeNS(null,”visibility”,”hidden”);
                    }
            }
        ]]>
    </script>
</svg>
</lsr:NewScene>
</saf:sceneUnit>
<saf:endOfSAFSession />
</saf:SAFSession>
```

The above external sensor event information includes event type information (<g on Humidity=“Humidity_change (evt)”>) and event attribute value information (textContent=evt.fValue;). The event attribute value information has an attribute of float Value type (textContent=evt.fValue;).

The above external sensor event information also has an image object defined to visualize the humidity value. Codes starting from “if(evt.fValue>80)” define that evtImage1 is shown on the display when the humidity is above 80, evtImage2 when the humidity is below 30, and evtImage3 in remaining cases.

Based on such external sensor event information, visualization information as illustrated in FIG. 7 can be shown on the display. The visualization information box 702 shows the current humidity (% unit) under the title “Humidity”, and includes an image object 704 visualizing the current humidity.

Assuming that the input unit 504 has received sensed information acquired by the length sensor, an example of external sensor event information is given below:

```
<?xml version=″1.0″ encoding=″ISO-8859-1″ ?>
<saf:SAFSession xmlns:saf=″urn:mpeg:mpeg4:SAF:2005″
xmlns:xlink=″http://www.w3.org/1999/xlink″
xmlns:ev=http://www.w3.org/2001/xml-events
xmlns:lsr=″urn:mpeg:mpeg4:LASeR:2005″
xmlns=″http://www.w3.org/2000/svg″>
<saf:sceneHeader>
<lsr:LASeRHeader />
</saf:sceneHeader>
<saf:sceneUnit>
<lsr:NewScene>
<svg xmlns=http://www.w3.org/2000/svg >
    <g onLength=“Length_change(evt)” >
<text id=“length_text” x=”10” y=“50”> </text>
</g>
    <script id=“length” type=“text/ecmascript”>
        <![CDATA[
            function Length_change(evt) {
                var evtText, textContent;
                evtText = document.getElementById(“length_text”);
if(evt.fValue < 2) {
textContent = “You're too close to the TV. Move back from the
TV.”;
}
else if(evt.fValue >= 2) {
textContent = “”;
                    }
evtText.firstChild.nodeValue = textContent;
            }
        ]]>
    </script>
</svg>
</lsr:NewScene>
</saf:sceneUnit>
<saf:endOfSAFSession />
</saf:SAFSession>
```

The above external sensor event information includes event type information (<g on Length=“Length change(evt)”>) and event attribute value information (evt.fValue). The event attribute value information has an attribute of float Value type (evt.fValue).

Codes starting from “if(evt.fValue<2)” define that, when the distance between the user and TV is less than 2 m, a warning message “You're too close to the TV. Move back from the TV.” is shown on the display.

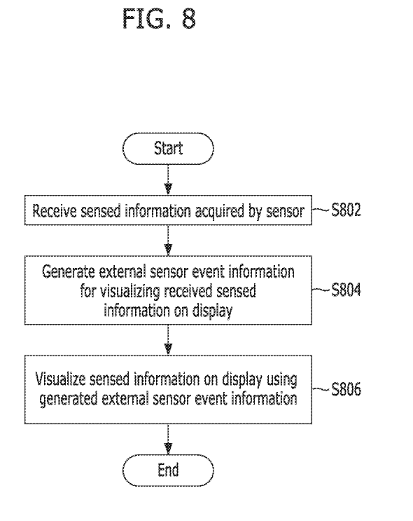

FIG. 8 is a flowchart of a method for providing user interaction in accordance with an embodiment of the present invention.

Firstly, sensed information acquired by a sensor is received at step S802. External sensor event information for visualizing the received sensed information on the display is generated at step S804. The external sensor event information includes event type information and event attribute value information. The event type information may include one of light type information, ambient noise type information, temperature type information, humidity type information, length type information, atmospheric pressure type information, position type information, velocity type information, acceleration type information, orientation type information, angular velocity type information, angular acceleration type information, force type information, torque type information, pressure type information, motion type information, and intelligent camera type information. The event attribute value information indicates an attribute of one of uniType type, time type, float Value type, string Value type, float Vector Value type, and float Vector List type.

The generated external sensor event information is used to visualize sensed information on the display at step S806. An event type, an event attribute value, and a visualization object are shown on the display, and the visualization object may vary as the event attribute value changes.

While the present invention has been described with respect to the specific embodiments, it will be apparent to those skilled in the art that various changes and modifications may be made without departing from the spirit and scope of the invention as defined in the following claims.

1. An apparatus for providing user interaction, comprising:
an input unit configured to receive control by a user;
a control processing unit configured to analyze the control and generate drag event information comprising event type information indicating a type of the control and event attribute information; and
an action processing unit configured to generate drag element information for showing an action corresponding to the control on a display, wherein
the drag element information comprises action mode information indicating a mode of the action and action attribute information.

2. The apparatus of claim 1, wherein the event type information comprises one of drag type information and drop type information.

3. The apparatus of claim 1, wherein the event attribute information comprises at least one of maximum angle information, minimum angle information, current angle information, maximum position information, minimum position information, and current position information.

4. The apparatus of claim 1, wherein the action mode information comprises one of drag plane mode information and drag rotation mode information.

5. The apparatus of claim 1, wherein the action attribute information comprises at least one of maximum angle information, minimum angle information, angle offset information, maximum position information, minimum position information, position offset information, and target element information.

6. A method for providing user interaction, comprising:
receiving control by a user;
analyzing the control and generating drag event information comprising event type information indicating a type of the control and event attribute information; and
generating drag element information for showing an action corresponding to the control on a display, wherein
the drag element information comprises action mode information indicating a mode of the action and action attribute information.

7. An apparatus for providing user interaction, comprising:
an input unit configured to receive sensed information acquired by a sensor; and
a control unit configured to generate external sensor event information for visualizing the sensed information on a display.

8. The apparatus of claim 7, wherein the external sensor event information comprises event type information and event attribute value information.

9. The apparatus of claim 8, wherein the event type information comprises one of light type information, ambient noise type information, temperature type information, humidity type information, length type information, atmospheric pressure type information, position type information, velocity type information, acceleration type information, orientation type information, angular velocity type information, angular acceleration type information, force type information, torque type information, pressure type information, motion type information, and intelligent camera type information.

10. The apparatus of claim 8, wherein the event attribute value information indicates an attribute of one of unitType type, time type, float Value type, string Value type, float Vector Value type, and float Vector List type.

11. The apparatus of claim 7, wherein the controller is configured to visualize the sensed information on the display using the external sensor event information,
an event type, an event attribute value, and a visualization object are shown on the display, and
the visualization object varies as the event attribute value changes.

12. A method for providing user interaction, comprising:
receiving sensed information acquired by a sensor; and
generating external sensor event information for visualizing the sensed information on a display.

13. The method of claim 12, wherein the external sensor event information comprises event type information and event attribute value information.

14. The method of claim 13, wherein the event attribute value information indicates an attribute of one of unitType type, time type, float Value type, string Value type, float Vector Value type, and float Vector List type.

15. The method of claim 12, wherein the method further comprises visualizing the sensed information on the display using the external sensor event information,
an event type, an event attribute value, and a visualization object are shown on the display, and
the visualization object varies as the event attribute value changes.
